(19) United States
(12) Patent Application Publication
(10) Pub. No.: US 2001/0026459 A1
(43) Pub. Date: Oct. 4, 2001

(54) Transformer

(76) Inventors: Yong-woon Han, Kunpo-city (KR); Seong-deog Jang, Suwon-city (KR); Kwang-seok Kang, Suwon-city (KR); Dae-sung Han, Hwasung-kun (KR); Jin-ho Kim, Suwon -city (KR); Han-seong Yoo, Yongin-city (KR); Han-sung Kang, Suwon-city (KR)

Correspondence Address: ROBERT E. BUSHNELL, 1522 K STREET NW, SUITE 300, WASHINGTON, DC, 200051202

(21) Appl. No.: 09/750,776

(22) Filed: Jan. 2, 2001

(30) Foreign Application Priority Data
Mar. 31, 2000 (KR) 17031-2000

(51) Int. Cl. H02M 3/335

(52) U.S. Cl. 363/24; 363/25

(57) ABSTRACT

A transformer having a coil winding structure for transforming a voltage which is inputted through a primary coil section and for outputting a transformed voltage toward a secondary coil section. In the transformer, the primary coil section includes a plurality of sub-coil sections which are connected in parallel, and a plurality of terminals are connected to the plurality of sub-coil sections, respectively, in a manner such that corresponding portions of the sub-coil sections have the same current direction.

### CLAIM OF PRIORITY

This application makes reference to, incorporates the same herein, and claims all benefits accruing under 35 U.S.C. §119 from my application TRANSFORMER filed with the Korean Industrial Property Office on Mar. 31, 2000 and there duly assigned Ser. No. 17031/2000.

### BACKGROUND OF THE INVENTION

2. Technical Field

The present invention relates to a microwave oven, and more particularly, to a transformer which has a coil winding structure capable of generating a sufficient output even in the case that a cross-sectional area of a coil wound around the high voltage transformer is reduced upon using a low frequency inverter.

2. Related Art

Generally, an inverter for a microwave oven is switched to a high frequency of no less than 20 kHz and is boosted to an adequate voltage. In this type of high frequency inverter, because the existing iron core cannot be used, a material which is prepared by adding other constituents to ferrite, is employed. In such a high frequency type inverter, noises are generated upon implementing a switching operation, and from this standpoint, it is difficult to satisfy a diversity of standards which were set for a microwave oven.

As a consequence, by using a low frequency inverter, various electrical parts of the existing microwave oven can be used. However, in the case of a high voltage transformer (HVT) which is used in the low frequency inverter, since an input voltage is very low such as 12V or 24V, in order to generate an adequate output which is required to drive the microwave oven, a current which approaches to 100 A (when a voltage is 12V), must be supplied.

Since a current amount is proportional to a cross-sectional area of a coil, in the case that such a large current is supplied, it is impossible to use the existing coil (a copper wire which has a diameter of less than Φ 1.5 mm in the case of a microwave oven), and instead, a cross-sectional area of a coil must be remarkably increased. By experiments, it was found that a cross-sectional area of 9 mm² is needed when a current of 80 A is supplied, and a copper wire having a diameter of Φ 3.3 mm must be wound around a high voltage transformer. However, when the copper wire having such a large diameter is wound around the high voltage transformer, in order to obtain the number of turns which is required in the high voltage transformer, a size of the high voltage transformer cannot but be markedly enlarged.

### SUMMARY OF THE INVENTION

Accordingly, the present invention has been made in an effort to solve the problems occurring in the related art, and an object of the present invention is to provide a transformer which has a coil winding structure capable of generating a sufficient output even in the case that a cross-sectional area of a coil wound around the high voltage transformer is reduced upon using a low frequency inverter.

In order to achieve the above object, according to one aspect of the present invention, there is provided a transformer having a coil winding structure for transforming a voltage which is inputted through a primary coil section and for outputting a transformed voltage toward a secondary coil section, the transformer characterized in that the primary coil section comprises a plurality of sub-coil sections which are connected in parallel, and a plurality of terminals are connected to the plurality of sub-coil sections, respectively, in a manner such that corresponding portions of the sub-coil sections have the same current direction.

According to another aspect of the present invention, the primary coil section serves as a coil section which is to be connected to a three-terminal inverter, and the plurality of sub-coil sections include first and second sub-coil sections; wherein each sub-coil section comprises first and second terminals which are formed at both ends of the sub-coil section and a third terminal which is led from an optional portion of a winding of the sub-coil section; and wherein, when the first and second sub-coil sections are connected to each other, third terminals of the first and second sub-coil sections are connected to a first pole of a power source, the first terminal of the first sub-coil section is connected to the second terminal of the second sub-coil section and then connected to a second pole of the power source via a first switching element of a push-pull circuit, and the second terminal of the first sub-coil section is connected to the first terminal of the second sub-coil section and then connected to the second pole of the power source via a second switching element of the push-pull circuit, whereby the first and second terminals are connected to the second pole of the power source via the first and second switching elements of the push-pull circuit, respectively.

According to another aspect of the present invention, the three-terminal inverter comprises a push-pull type inverter.

According to still another aspect of the present invention, the primary coil section serves as a coil section which is to be connected to a two-terminal inverter, each sub-coil section comprises first and second terminals which are formed at both ends of the sub-coil section, and first terminals of the sub-coil sections are connected to a first pole of a power source and second terminals of the sub-coil sections are connected to a second pole of the power source.

According to yet still another aspect of the present invention, the two-terminal inverter comprises a rotation type inverter.

### BRIEF DESCRIPTION OF THE DRAWINGS

The above objects, and other features and advantages of the present invention will become more apparent after a reading of the following detailed description when taken in conjunction with the drawings, in which:

FIGS. 1A and 1B are perspective views respectively illustrating sub-coil sections which are connected in parallel to a primary coil section, in a high voltage transformer for a microwave oven according to a first embodiment of the present invention;

FIGS. 2A and 2B are schematic views illustrating winding structures of the sub-coil sections shown in FIGS. 1A and 1B;

FIG. 3 is a circuit diagram of the transformer according to the first embodiment of the present invention, which is applied to a push-pull type inverter by connecting in parallel the sub-coil sections of FIGS. 1A and 1B;

FIGS. 4A and 4B are perspective views respectively illustrating sub-coil sections which are connected in parallel to a primary coil section, in a high voltage transformer for a microwave oven according to a second embodiment of the present invention;

FIGS. 5A and 5B are schematic views illustrating winding structures of the sub-coil sections shown in FIGS. 4A and 4B; and

FIG. 6 is a circuit diagram of the transformer according to the second embodiment of the present invention, which is applied to a two-terminal inverter by connecting in parallel the sub-coil sections of FIGS. 4A and 4B.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

For reference, a first embodiment of the present invention represents a case in which sub-coil sections of a primary coil section are connected in parallel to be applied to a push-pull type inverter, and a second embodiment of the present invention represents another case in which sub-coil sections of a primary coil section are connected in parallel to be applied to a rotation type inverter.

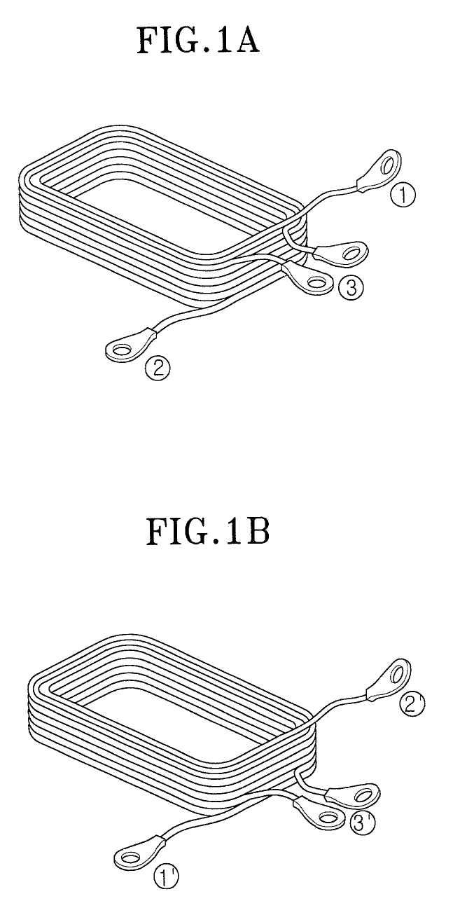

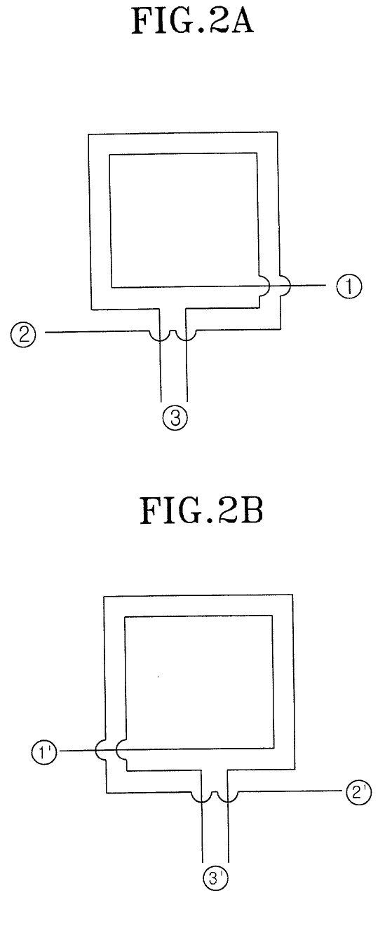

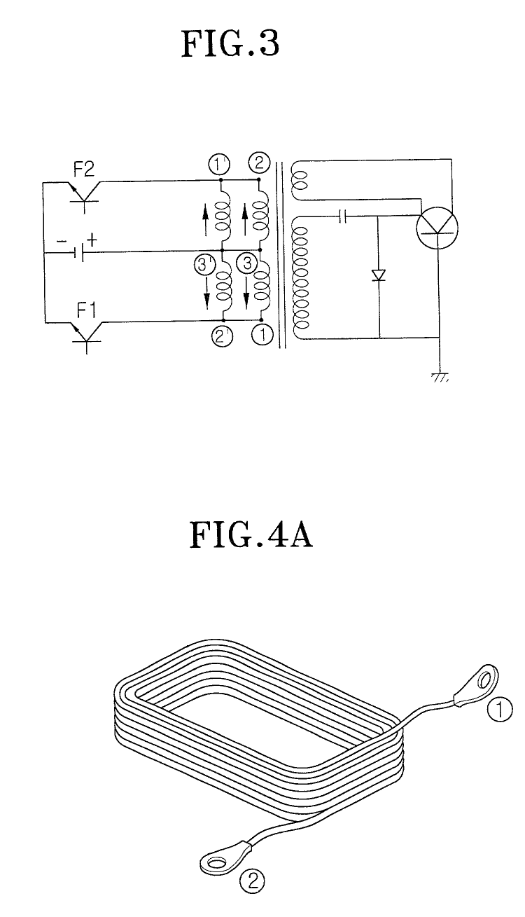

FIGS. 1A and 1B are perspective views respectively illustrating sub-coil sections which are connected in parallel to a primary coil section, in a high voltage transformer for a microwave oven according to a first embodiment of the present invention. FIGS. 2A and 2B are schematic views illustrating winding structures of the sub-coil sections shown in FIGS. 1A and 1B, and FIG. 3 is a circuit diagram of the transformer according to the first embodiment of the present invention, which is applied to a push-pull type inverter by connecting in parallel the sub-coil sections of FIGS. 1A and 1B.

As shown in FIGS. 1A and 1B, a primary coil section of a transformer comprises sub-coil sections which are connected in parallel. A first sub-coil section shown in FIG. 1A and a second sub-coil section shown in FIG. 1B are wound to have the same configuration. The second sub-coil section shown in FIG. 1B is illustrated in a state wherein the first sub-coil section shown in FIG. 1A is rotated by an angle of 180°. The first and second sub-coil sections serve as sub-coil sections which are to be connected to a three-terminal inverter, for example, the push-pull type inverter. Each sub-coil section has a first terminal 1 or 1′ and a second terminal 2 or 2′ which are formed at both ends of the sub-coil section and a third terminal 3 or 3′ which is led from an optional portion of a winding of the sub-coil section.

As shown in FIG. 3, when the first and second sub-coil sections are connected to each other, the third terminals 3 and 3′ of the first and second sub-coil sections are connected to a first pole (a positive pole) of a power source, the first terminal 1 of the first sub-coil section is connected to the second terminal 2′ of the second sub-coil section and then connected to a second pole (a negative pole) of the power source via a first switching element F1 of a push-pull circuit, and the second terminal 2 of the first sub-coil section is connected to the first terminal 1′ of the second sub-coil section and then connected to the second pole (the negative pole) of the power source via a second switching element F2 of the push-pull circuit.

Accordingly, the primary coil section comprises a plurality of first and second sub-coil sections which are connected with each other in parallel. A plurality of terminals are connected to the plurality of sub-coil sections, respectively, in a manner such that corresponding portions of the sub-coil sections have the same current direction.

Further, although, in the first sub-coil section, a coil length between the first terminal 1 and the third terminal 3 and a coil length between the second terminal 2 and the third terminal 3 are different from each other and, in the second sub-coil section, a coil length between the first terminal 1′ and the third terminal 3′ and a coil length between the second terminal 2′ and the third terminal 3′ are different from each other, because the first terminal 1 of the first sub-coil section is connected to the second terminal 2′ of the second sub-coil section and the second terminal 2 of the first sub-coil section is connected to the first terminal 1′ of the second sub-coil section thereby to define a symmetric structure, the same inductance and resistance are obtained in the sub-coil sections which are connected to the first and second switching elements F1 and F2 along respective directions in the circuit diagram of FIG. 3.

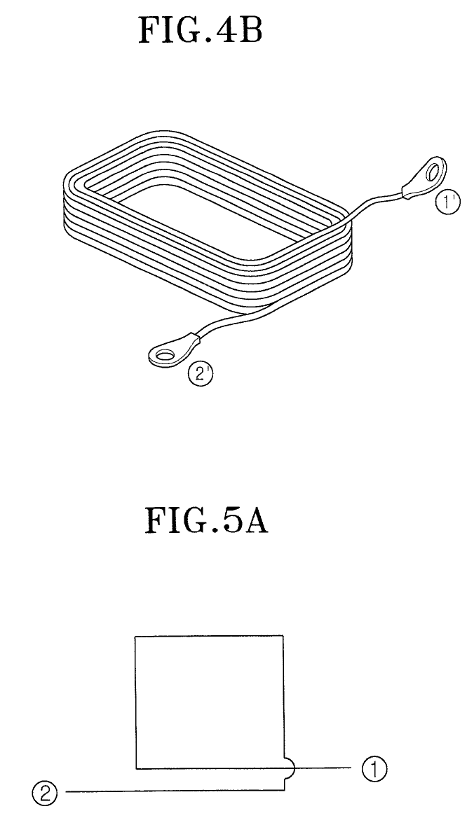

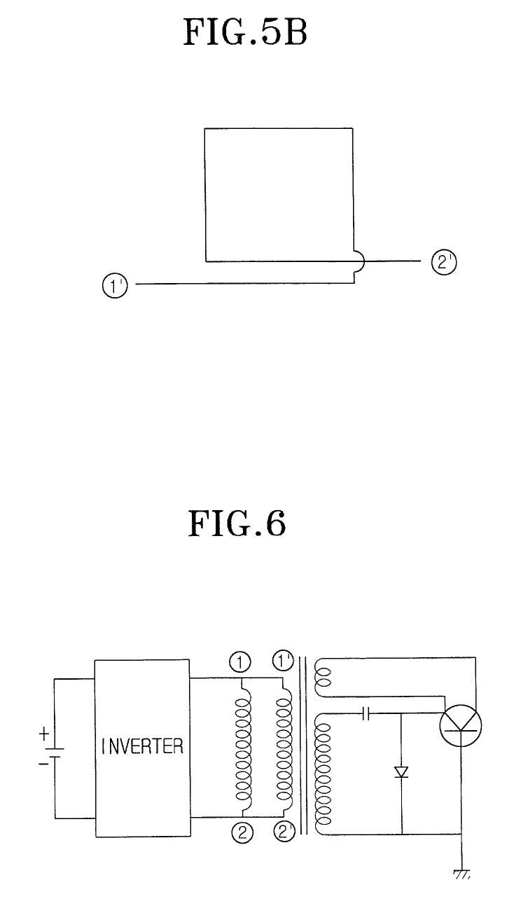

FIGS. 4A and 4B are perspective views respectively illustrating sub-coil sections which are connected in parallel to a primary coil section, in a high voltage transformer for a microwave oven according to a second embodiment of the present invention. FIGS. 5A and 5B are schematic views illustrating winding structures of the sub-coil sections shown in FIGS. 4A and 4B, and FIG. 6 is a circuit diagram of the transformer according to the second embodiment of the present invention, which is applied to a two-terminal inverter by connecting in parallel the sub-coil sections of FIGS. 4A and 4B.

As shown in FIGS. 4A and 4B, a primary coil section of a transformer comprises sub-coil sections which are connected in parallel. A first sub-coil section shown in FIG. 4A and a second sub-coil section shown in FIG. 4B are wound to have the same configuration. The first and second sub-coil sections serve as sub-coil sections which are to be connected to a two-terminal inverter, for example, the rotation type inverter. Each sub-coil section has a first terminal 1 or 1′ and a second terminal 2 or 2′ which are formed at both ends of the sub-coil section.

As shown in FIG. 6, when the first and second sub-coil sections are connected with each other, the first terminals 1 and 1′ of the first and second sub-coil sections are connected to a first pole (a positive pole) of a power source, and the second terminals 2 and 2′ of the first and second sub-coil sections are connected to a second pole (a negative pole) of the power source.

Accordingly, the primary coil section comprises a plurality of first and second sub-coil sections which are connected with each other in parallel. A plurality of terminals are connected to the plurality of sub-coil sections, respectively, in a manner such that corresponding portions of the sub-coil sections have the same current direction.

Hence, in the case that a low frequency inverter is used as an inverter which is connected to a primary coil section of a high voltage transformer of a microwave oven, it is possible to decrease resistance in a sufficient manner by adopting a method in which a copper wire having a small radius is used and respective windings are connected in parallel in many times, whereby the number of turns which is required in the high voltage transformer, can be accomplished and inductance of a desired value can be obtained.

As a result, by the transformer, according to the present invention, having the above-described coil winding structure, advantages are provided in that, since it is possible to generate a sufficient output even in the case that a cross-sectional area of a coil wound around the high voltage transformer is reduced upon using a low frequency inverter, a volume of the high voltage transformer can be reduced.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A transformer having a coil winding structure for transforming a voltage which is inputted through a primary coil section and for outputting a transformed voltage toward a secondary coil section, the transformer characterized in that the primary coil section comprises a plurality of sub-coil sections which are connected in parallel, and a plurality of terminals are connected to the plurality of sub-coil sections, respectively, in a manner such that corresponding portions of the sub-coil sections have the same current direction.

2. The transformer as claimed in claim 1, wherein the primary coil section serves as a coil section which is to be connected to a three-terminal inverter, and the plurality of sub-coil sections include first and second sub-coil sections; wherein each sub-coil section comprises first and second terminals which are formed at both ends of the sub-coil section and a third terminal which is led from an optional portion of a winding of the sub-coil section; and wherein, when the first and second sub-coil sections are connected to each other, the third terminals of the first and second sub-coil sections are connected to a first pole of a power source, the first terminal of the first sub-coil section is connected to the second terminal of the second sub-coil section and then connected to a second pole of the power source via a first switching element of a push-pull circuit, and the second terminal of the first sub-coil section is connected to the first terminal of the second sub-coil section and then connected to the second pole of the power source via a second switching element of the push-pull circuit, whereby the first and second terminals are connected to the second pole of the power source via the first and second switching elements of the push-pull circuit, respectively.

3. The transformer as claimed in claim 2, wherein the three-terminal inverter comprises a push-pull type inverter.

4. The transformer as claimed in claim 1, wherein the primary coil section serves as a coil section which is to be connected to a two-terminal inverter, each sub-coil section comprises first and second terminals which are formed at both ends of the sub-coil section, and first terminals of the sub-coil sections are connected to a first pole of a power source and second terminals of the sub-coil sections are connected to a second pole of the power source.

5. The transformer as claimed in claim 4, wherein the two-terminal inverter comprises a rotation type inverter.
